(19) United States
(12) Patent Application Publication
(10) Pub. No.: US 2018/0286363 A1
(43) Pub. Date: Oct. 4, 2018

(54) SYSTEMS AND METHODS FOR RECORDING AND TRANSCRIBING MUSIC

(71) Applicant: Gregory Saul Harrison, Aliso Viejo, CA (US)

(72) Inventor: Gregory Saul Harrison, Aliso Viejo, CA (US)

(21) Appl. No.: 15/353,567

(22) Filed: Nov. 16, 2016

Related U.S. Application Data
(60) Provisional application No. 62/256,554, filed on Nov. 17, 2015.

(51) Int. Cl. G10G 1/04; G10G 3/04; G11B 20/10

(52) U.S. Cl. CPC G10G 1/04; G11B 2020/10546; G11B 20/10527; G10G 3/04

(57) ABSTRACT

A system for recording and transcribing music can comprise a sound-capturing device, a control device, memory, and a communication module. A sound-capturing device can record music. The control device can be configured to activate the sound-capturing device. Memory can be communicatively coupled to the sound-capturing device. The memory can be configured to store a recording of the music from the music instrument. A sound-capturing device, control device, and memory can be arranged and configured to couple to a music instrument. A communication module can be communicatively coupled to the memory, wherein the communication module is arranged and configured to wirelessly transmit data.

### CROSS-REFERENCE TO RELATED APPLICATIONS

This application claims the benefit of U.S. Provisional Patent Application No. 62/256,554; filed Nov. 17, 2015; and entitled A SMART INSTRUMENT SYSTEM AND METHOD TO CAPTURE AND TRANSCRIBE MUSIC. The entire contents of U.S. Provisional Patent Application No. 62/256,554 are incorporated herein by reference.

### BACKGROUND

### Field of Invention

The present invention relates to recording and transcribing and more specifically to recording music and transcribing it into musical notes and/or tablature.

### Description of Related Art

Musicians sometimes record music in recording studios. However, renting a recording studio can be expensive and inconvenient. Accordingly, musicians often use personal recording devices, such as smart phones. However, smart phones have significant limitations in that they are unable to transcribe the music into a readable medium. What is even more troublesome is that smartphones are unable to capture a quality recording of the music. Therefore, there is a need in the art for a solution that allows musicians to cost effectively and conveniently capture a quality recording of a musical sequence while also being able to transcribe the music into a readable format.

### SUMMARY

The present disclosure describes a system for recording and transcribing music. This system can comprise a sound-capturing device that can be arranged and configured to couple to a music instrument. The sound-capturing device can record music. The system can also comprise a control device that can be communicatively coupled to the sound-capturing device. The control device can be arranged and configured to couple to the music instrument and can be configured to activate the sound-capturing device. The system can also comprise memory that can be communicatively coupled to the sound-capturing device and can be arranged and configured to couple to the music instrument. The memory can be configured to store a recording of the music from the music instrument. The system can further comprise a communication module that can be communicatively coupled to the memory. The communication module can be arranged and configured to wirelessly transmit data.

In some embodiments of the system, a remote computing device can be communicatively coupled to the communication module. A software application can be implemented on the remote computing device, wherein the remote computing device can be configured to audibly playback the recording of the music from the music instrument via the software application. The software application can be configured to transcribe the recording of the music from the music instrument into one of musical notes and tablature.

The system can further comprise the music instrument and the sound-capturing device can be coupled to the music instrument. As well, the control device and memory can be coupled to the music instrument. In some embodiments, the music instrument defines at least one of a percussion instrument (e.g. drums, pianos, bongos, and the like), a brass instrument (e.g. trumpets, trombones, tubas, and the like), an electrical instrument (e.g. keyboards, turn tables, synthesizers, electronic drums, and the like), a woodwind instrument (e.g. saxophones, flutes, clarinets, and the like), and a string instrument (e.g. guitars, banjos, basses, ukuleles and the like), and musical accessories, and recording equipment (e.g. amplifiers, preamplifiers, sound processers, audio processors, speakers, effects pedals, effect microphones, recording consoles, mixing consoles, and the like).

The sound-capturing device can comprise at least one of a pickup and a microphone. The control device can comprise at least one of a pickup selector, a knob, a button, and an LCD screen. The control device can be operable in a recording mode. The control device can command the sound-capturing device to record music. A transmit mode on the control device can cause the system to transmit the recording to the remote computing device.

The system can further comprise a second music instrument. Accordingly, a second sound-capturing device can be coupled to the second music instrument whereby the second sound-capturing device can record music. The system can also comprise a second control device that can be communicatively coupled to the second sound-capturing device and coupled to the second music instrument. The second control device can be configured to activate the second sound-capturing device. The system can also comprise a second memory that can be communicatively coupled to the second sound-capturing device and coupled to the second music instrument. The second memory can be configured to store a recording of the music from the second music instrument.

The system can also comprise a second communication module that can be communicatively coupled to the second memory. The second communication module can be arranged and configured to wirelessly transmit data. As well, the system can comprise a second remote computing device that can be communicatively coupled to the second communication module. The software application can be implemented on the second remote computing device, which can be configured to audibly playback the recording via the software application.

In several embodiments, the music instrument can be a first music instrument and the remote computing device can be a first remote computing device. The control device can be further operable in a discovery mode whereby the first remote computing device and the second remote computing device can communicate with each other. The first remote computing device can receive the recording of the music from the second music instrument. As well, the second remote computing device can receive the recording of the music from the first music instrument.

This disclosure also includes a method of using the system comprising a sound-capturing device that can be coupled to a first music instrument, and a control device that can be communicatively coupled to the sound-capturing device and coupled to the first music instrument. The system can also include memory communicatively coupled to the sound-capturing device and coupled to the first music instrument. Additionally, the system can include a communication module communicatively coupled to the memory, and a remote computing device communicatively coupled to the communication module. In some embodiments, the system includes a software application implemented at least in part by the remote computing device.

Some methods can include recording, via the sound-capturing device, music from the first music instrument. The method can further comprise storing, via the memory, a recording of the music from the first music instrument. Additionally, the method can further comprise transmitting, via the communication module, the recording of the music to the remote computing device. Even still, the method can comprise transcribing, via the software application, the recording of the music into musical notes.

In several embodiments, the recording occurs in response to receiving a first input via a control device, which can be communicatively coupled to the sound-capturing device and coupled to the first music instrument. The method can thereby comprise terminating the recording in response to receiving a second input via the control device.

The method can further comprise emitting a playback of the recording via a speaker of the remote computing device. As well, the method can include displaying a transcription of the recording via a display screen on the remote computing device.

In several embodiments, the system can be a first system and the remote computing device can be a first remote computing device. The method can further comprise discovering, via the communication module, at least a second system. The method can further comprise pairing, via the communication module, the first system with a second system. The second system can comprise a second sound-capturing device that can be coupled to a second music instrument. The second system can further comprise a second control device that can be communicatively coupled to the second sound-capturing device. The second system can also be coupled to the second music instrument. A second memory can be communicatively coupled to the second sound-capturing device and can be coupled to the second music instrument. A second communication module can be communicatively coupled to the second memory. A second remote computing device can be communicatively coupled to the second communication module. The software application can be implemented at least in part by the second remote computing device.

In some embodiments of the method, the system can be a first system. The method can further comprise discovering, via the communication module, at least a second system. The method can further comprise pairing, via the first remote computing device, the first system with the second system. The second system can comprise a second sound-capturing device that can be coupled to a second music instrument. A second control device can be communicatively coupled to the second sound-capturing device and can be coupled to the second music instrument. A second memory can be communicatively coupled to the second sound-capturing device and can be coupled to the second music instrument. A second communication module can be communicatively coupled to the second memory. A second remote computing device can be communicatively coupled to the second communication module. The software application can be implemented at least in part by the second remote computing device.

The method can comprise recording, via the second sound-capturing device, music from the second music instrument. The method can further comprise storing, via the second memory, a recording of the music from the second music instrument. The method can further comprise transmitting, via the second communication module, the recording of the music from the second music instrument to the second remote computing device. The method can further comprise transcribing, via the software application, the recording of the music from the second music instrument into musical notes.

The method can further comprise transmitting, via the second remote computing device, the recording of the music to the first remote computing device. The method can further comprise transmitting, via the first remote computing device, the recording of the music to the second remote computing device.

Even still, the method can comprise emitting a playback of the recording of the music from the second music instrument via at least one of a speaker of the second remote computing device and a speaker communicatively coupled to the second remote computing device. The method can further comprise displaying a transcription of the recording of the music from the second music instrument via a display screen on the second remote computing device.

In some embodiments, the method comprises emitting the playback of the recording of the music from the second music instrument via at least one of the speaker of the first remote computing device and a speaker communicatively coupled to the first remote computing device. The method can further comprise displaying the transcription of the recording of the music from the second music instrument via the display screen on the first remote computing device.

In several embodiments, the method comprises emitting the playback of the recording of the music from the first music instrument via at least one of the speaker of the second remote computing device and a speaker communicatively coupled to the second remote computing device. The method can further comprise displaying the transcription of the recording of the music from the first music instrument via the display screen on the second remote computing device.

The method can also comprise transmitting the recording of the music from the first music instrument to a remote server that can be communicatively coupled to at least one of the first system and the second system. In some embodiments, the method comprises transmitting the recording of the music from the second music instrument to the remote server.

Other objects and advantages of the embodiments herein will become readily apparent from the following detailed description taken in conjunction with the accompanying drawings. The embodiments described above include many optional features and aspects. Features and aspects of the embodiments can be combined.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIGS. 1 and 2 illustrate diagrams of the system, according to some embodiments.

FIG. 3 illustrates instrument families, according to some embodiments.

FIG. 4 illustrates a sound-capturing device, according to some embodiments.

FIG. 5 illustrates a control device, according to some embodiments.

FIG. 6 illustrates a remote computing device, according to some embodiments.

FIG. 7 illustrates a system being used by two instruments, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Additionally, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

### Introduction

Musical inspiration is ephemeral. If a song idea isn't captured in the moment it's imagined, there's a good chance it will be lost forever. That's why songwriters usually keep a mobile device (or tape recorder, if they're old school) nearby at all times; it's impossible to predict when inspiration will strike.

But relying on a third party device to capture a song idea has several inherent drawbacks. First, a recording device isn't always easily accessible. And even when a recording device is accessible, it can be somewhat awkward to play an instrument while positioning the device to capture the recording. Guitarists, for example, will often have to balance a smartphone on their knee while playing the song they want to record.

Next, seconds count when trying to capture a spontaneous performance, and manipulating mobile apps can be slow and frustrating. The process usually involves unlocking a mobile device, opening a recording app, starting the recording, stopping a recording, naming the recording or, deleting the recording and re-engaging the recording function. This is a lot of work to capture a simple song idea, and it disrupts the creative process.

Third, typical recording quality can be poor, and background noise can often obscure the sound of the performance. Even if the songwriter manages to capture a decent recording of the song, they won't necessarily be able to go back later and discern exactly how they played the song. This is particularly the true when trying to recreate a performance months (or even years) later. Most musicians do not have perfect pitch, so recalling exactly what notes and chords were played, is often very challenging. As well, once recorded, most standard recording apps don't provide a method for organizing or editing the recordings.

Prior art solutions fail to address the concerns addressed above. For starters, most third party hardware needs to be plugged into an instrument and in some cases, a mobile device as well. This prerequisite limits the device's utility, because the user needs to locate the device, connect the device, and in some cases, activate the mobile application.

Dedicated mobile apps are also inherently flawed because they require the use of a mobile device, and tend to have a fairly robust user interface. These mobile applications are more suited for a premeditated recording session, not an improvisational performance.

Implementing the systems and methods of this disclosure can solve all of these problems. The teachings of this disclosure will allow a musician to instantly record what is being played on their instrument, and then accurately transcribe that performance without relying on a third party recording device. The systems described herein can be built directly into instruments by the original equipment manufacturer, or added to an existing instrument as an aftermarket accessory.

### Recording and Transcription Systems and Methods

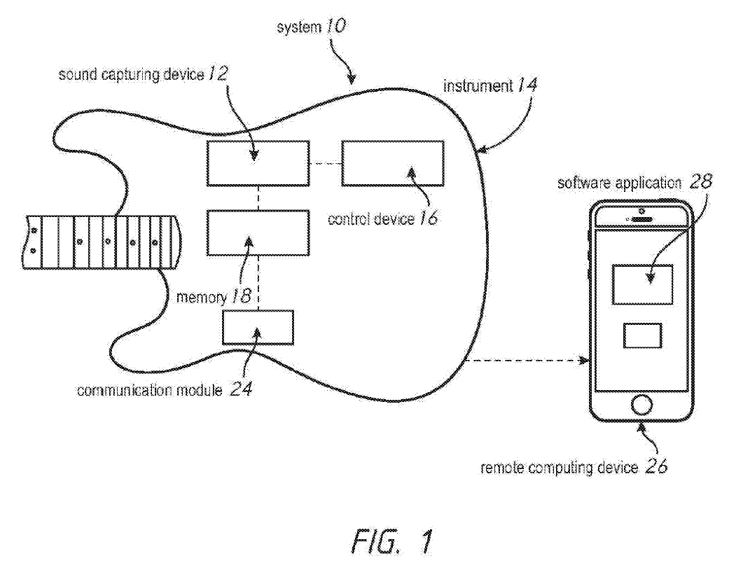

Referring to FIG. 1, a system 10 for recording and transcribing music 22 can include a musical instrument 14, a sound-capturing device 12, a control device 16, memory 18, and a communication module 24. In some embodiments, the system 10 includes a communication module 24 and a remote computing device 26.

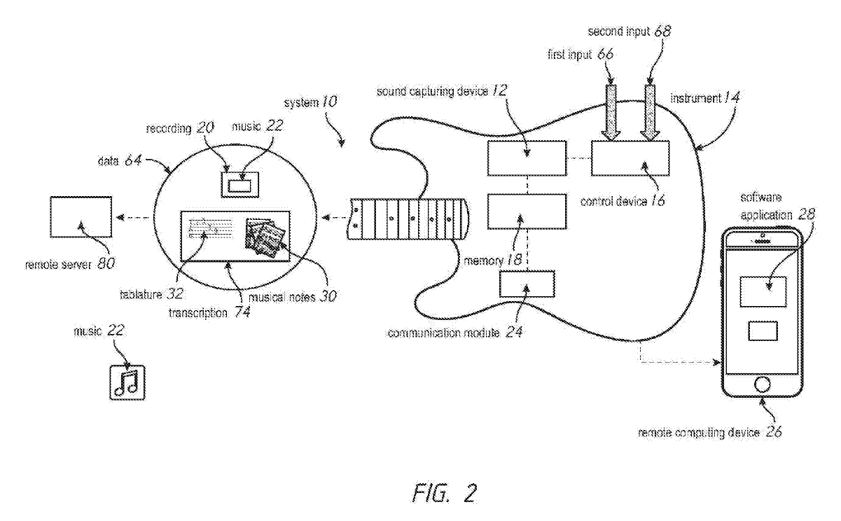

As illustrated in FIG. 2, the system 10 can include a sound-capturing device 12 arranged and configured to couple to a music instrument 14. It should be appreciated that the sound-capturing device records music. The system 10 can also include a control device 16 communicatively coupled to the sound-capturing device 12 and arranged and configured to couple to the music instrument 14. The control device 16 can be configured to activate the sound-capturing device 12. In some embodiments, the system 10 can also include memory 18 communicatively coupled to the sound-capturing device 12 and arranged and configured to couple to the music instrument 14. It should be appreciated that the memory 18 can be configured to store a recording 20 of the music 22 from the music instrument 14. The system can even include a communication module 24 communicatively coupled to the memory 18. The communication module 24 can be arranged and configured to wirelessly transmit data 64. The communication module 24 can be coupled to the instrument 14 (as shown in FIG. 1) or the communication module 24 can be located remotely with respect to the instrument 14 (as shown in FIG. 2). In either embodiment, the communication module 24 can be communicatively coupled to at least one of the sound-capturing device 12, control device 16, and the memory 18.

As further shown in FIGS. 1 and 2, in some embodiments, the system 10 includes a remote computing device 26 communicatively coupled to the communication module 24. The remote computing device 26 can include devices, such as smartphones, tablets, laptops, smartwatches, and the like. The system 10 can even include a software application 28 (e.g. mobile application) implemented, at least in part, on the remote computing device 26. The remote computing device 26 can thereby be configured to audibly playback the recording 20 of the music 22 (e.g. emit music 22 from a speaker of the remote computing device 26) from the music instrument 14 via the software application 28. The software application 28 can thereby be configured to transcribe the recording 20 of the music 22 from the music instrument 14 into at least one of musical notes 30 and tablature 32.

Referring to FIG. 2, in some embodiments, recording music 22 can be implemented in response to receiving a first input 66 via a control device 16. For example, the first input 66 may be the musician toggling a switch on the control device 16 from the off position to the record position. Furthermore, terminating the recording 20 can be implemented in response to receiving a second input 68 via the control device 16. The second input 68 can be, for example, the musician pressing a transmit button on the control device 16.

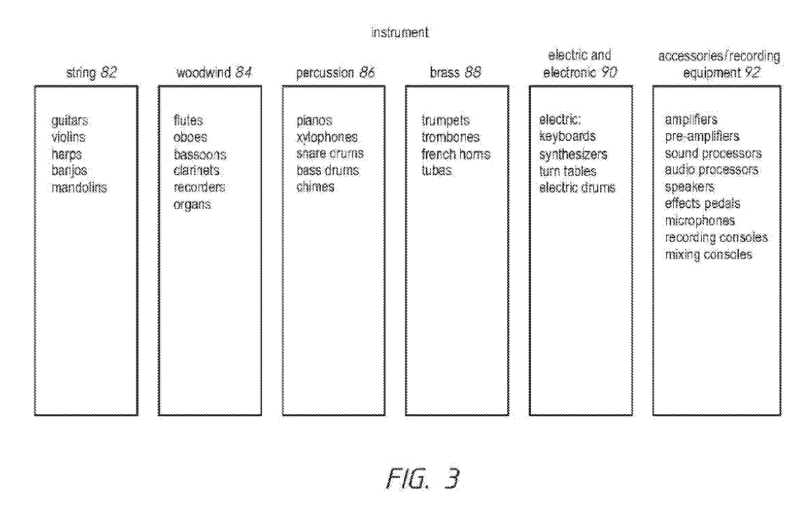

The disclosure includes musical instruments 14 that can be categorized into families based on how they make sounds. As shown in FIG. 3, these families can include string 82, woodwind 84, percussion 86, brass 88, and electric or electronic 90 instruments. In several embodiments, the music instrument can define at least one of a string 82 (e.g. guitar, violin, banjo), woodwind 84 (e.g. saxophone, flute, clarinet), percussion 86 (e.g. drums, xylophone, piano), brass 88 (e.g. trumpet, trombone, tuba), and electric or electronic 90 (e.g. keyboard, synthesizer, effects pedal, amplifier). It should be noted that the human voice can also be used to produce sound and make music, even though it may not be categorized in an instrument family. While the disclosed system may not necessarily be coupled to a musician's voice, the system components may be coupled to a device, such as a microphone. The microphone and voice combination may then be able to act as an instrument 14 in the system and can allow a musician to record and transpose music produced by vocals.

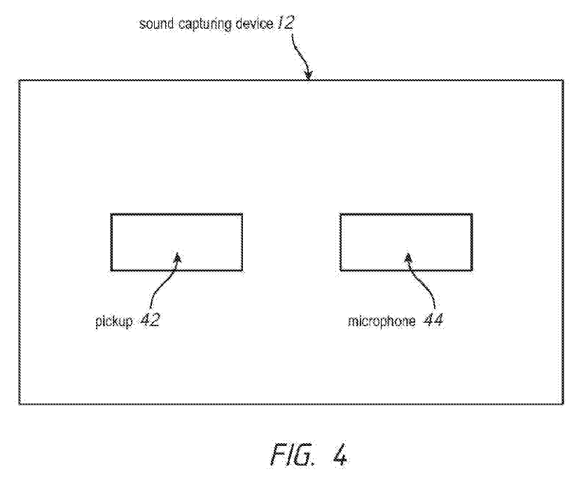

As shown in FIG. 4, in some embodiments, the sound-capturing device 12 can be arranged and configured to couple to a musical instrument 14. As its name implies, the sound-capturing device 12 can record music 22. In some embodiments, the sound-capturing device 12 includes an instrumental pickup 42, such as a transducer (e.g. a variable reluctance sensor) that captures or senses mechanical vibrations from a variety instruments, such as electric guitars, electric bass guitars, and electric violins. The pickup 42 can convert the mechanical vibrations to electrical signals that are then amplified using an instrument amplifier, such as a guitar or bass amplifier, to produce musical sounds through a loudspeaker. In some embodiments, the signal from a pickup 42 can also be recorded directly, using a Direct box, or DI box. DI's are generally used in recording studios to connect an instrument, such as an electric bass or electric guitar, to a mixing console's input. This direct connection helps to minimize noise and distortion. The signal from the pickup 42 can also be used to broadcast sound from the instrument via a mobile application, the internet, radio or television. Most electric guitars and electric basses use magnetic pickups. Acoustic guitars, upright basses and fiddles often use piezoelectric pickups.

Sound-capturing devices 12 can record and reproduce sound waves, such as in singing, speaking, or instrumental music. Other examples of sound-capturing devices 12 can include microphones 44, cassette recorders, computers, smartphones, and the like. Oftentimes, analog sound signals are picked up by a microphone 44. These analog sounds can then be converted into a digital recording. In many home sound-capturing devices 12, microphones may not be high quality and can result in the introduction of noise and interference in the recorded sounds.

The system 10 can include multiple sound-capturing devices 14 (e.g. pickups 42 or microphones 44). In some embodiments, sound-capturing devices 14 (or pickups 42) can be coupled to instruments 14 to amplify an instruments' sound, or change the tone of the sound. For example, an electric guitar can have two or three pickups 42 coupled to the instrument body. A first pickup 42a can be located close to bridge of the instrument, a second pickup 42b can be located at the neck of the instrument, and a third pickup 42c can be located in the center of the instrument body. When selected, each different pickup will produce a different sound. The second pickup 42b (i.e. neck pickup), may produce a “darker” or more mellow sound, while the first pickup 42a (i.e. bridge pickup) will produce a “brighter” sound, or an emphasis on the higher tones. Accordingly, these pickups 42 can be used to create the sounds captured by the sound-capturing device 12.

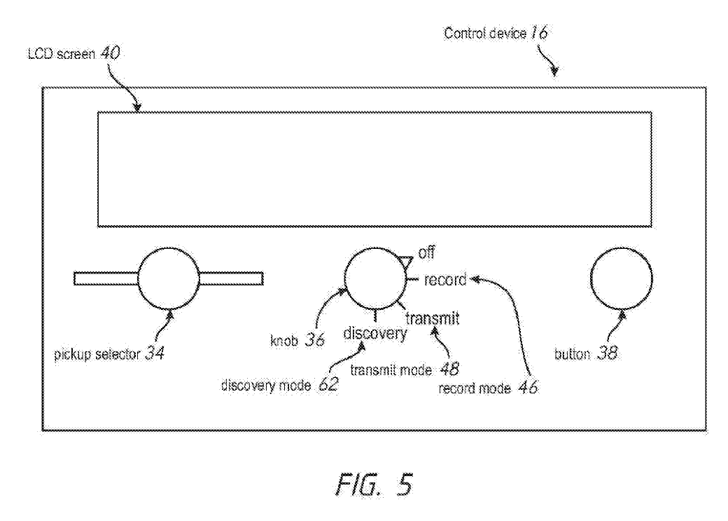

As shown in FIG. 5, the control device 16 can comprise at least one of a pickup selector 34, a knob 36, a button 38, and an LCD screen 40. Instruments that utilize multiple pickups 42 can have a pickup selector 34. The pickup selector 34 can be a lever or switch that can allow a musician to select a pickup 42, such as neck or bridge, by sliding the switch to position that turns on a particular pickup 42.

Furthermore, the control device 16 may include a knob 36 (or any type of control mechanism), which can command the system 10 to perform various operations. For example, the control device 16, via the knob 36, can be operated in a recording mode 46, where the control device 16 commands the sound-capturing device 12 to record music 22. The control device 16 can also be operated in a transmit mode 48, whereby the control device 16 can cause the system 10 to transmit the recording 20 to the remote computing device 26. Selecting either the record mode 46 or transmit mode 48 can be done by using any type of control mechanism, such as a knob 36, a button 38, a slide, a dial, a lever, and the like. For example, a lever can be moved to a record position or a transmit position. For a knob 36, the knob 36 can be dialed to certain positions for different modes. For a button 38, the one or more buttons can be pressed to turn a mode on or off. In addition to knobs 36, and buttons 38, other switches or toggles, such as a bat handle toggle or a rocker switch, can also be used to change modes.

In some cases, the sound-capturing device 12, the control device 16, and the memory 18 can be coupled to the music instrument 14 during the manufacture of the instrument. The manufacturer can thereby offer the system 10 as an original equipment manufacturer (a.k.a. OEM). Another option may be that the sound-capturing device 12, control device 16, and memory 18 can be coupled to an instrument 14 as an after-market accessory or solution. In the after-market embodiment, the system 10 can be coupled to the music instrument 14 in a temporary manner, such as with adhesive, or a more permanent manner, such as with screws, fasteners, or more permanent adhesive.

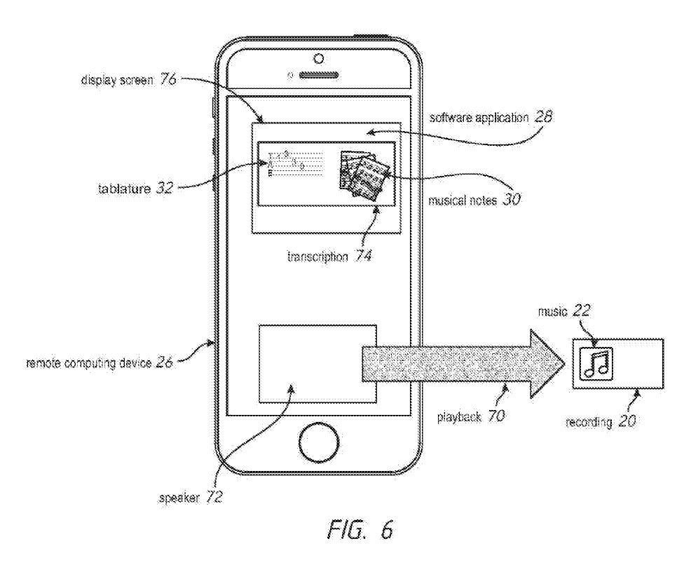

As shown in FIG. 6, the system 10 can include a remote computing device 26 that can be communicatively coupled via the communication module 24. The remote computing device 26 may include a speaker 72 and a display screen 76. The remote computing device 26 may implement a software application 28 (e.g. mobile application) that can perform various features, such as emitting a playback 70 of the music, transcribing the music into notes 30 and/or tablature 32, and thereby displaying a transcription 74 of the recording 20 via the display screen 76 on the remote computing device 26, and even storing various recordings 20 and transcriptions 74 for future reference.

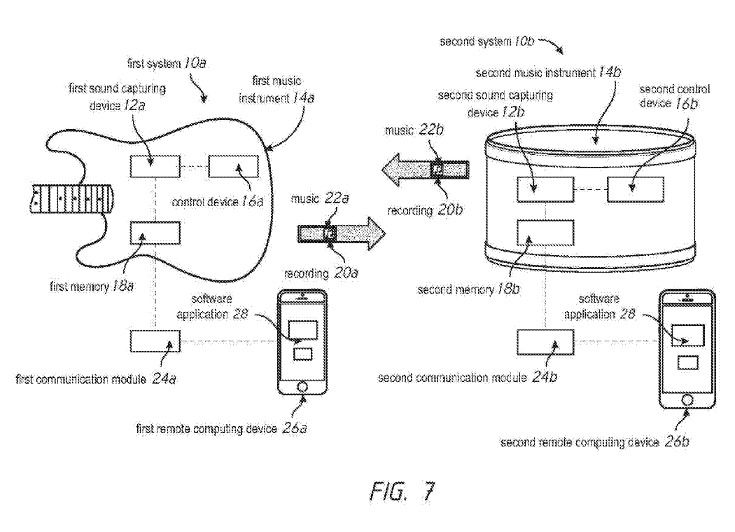

This system 10 can also lend itself well to being used by music groups or bands. As illustrated in FIG. 7, in some embodiments, the system 10 is a first system 10a and the disclosure includes a second system 10b that comprises a second music instrument 14b, a second sound-capturing device 12b, a second control device 16, a second memory 18b, a second communication module 24b, and a second remote computing device 26b. As in the first system 10a, the second sound-capturing device 12b can be coupled to the second music instrument 14b and be used to record music 22b. A second control device 16b can be communicatively coupled to the second sound-capturing device 12b and can be coupled to the second music instrument 14b. Likewise, the second control device 16b can be configured to activate the second sound-capturing device 12b. A second memory 18b can be communicatively coupled to the second sound-capturing device 12b and can be coupled to the second music instrument 14b. The second memory 18b can also be configured to store a recording 20 of the music 22 from the second music instrument 14b. A second communication module 24b can be communicatively coupled to the second memory 18b and can be arranged and configured to wirelessly transmit data 64. A second remote computing device can be communicatively coupled to the second communication module 24. The software application 28 can be implemented on the second remote computing device 26b, such as the second musician's smartphone or tablet. The second remote computing device 26b can be configured to audibly playback the recording 20b via the software application 28.

When used in a group or band setting, the system 10 can be used to allow two or more instruments to communicate with each other. For example, in several embodiments, the control device 16 of the first instrument 14 can be operable in a discovery mode 62. In some embodiments, a knob 36, pickup selector 34, button 38, and the like, may be used to select at least one of a record mode 46, a transmit mode 48, and a discovery mode 62. When in discovery mode 62, the first remote computing device 26 and the second remote computing device 26b may be able to communicate with each other. The first remote computing device 26 may be able to receive the recording 20 of the music 22 from the second music instrument 14b, and the second remote computing device 26b may be able to receive the recording 20a of the music 22a from the first music instrument 14. Likewise, this can be used with more than two instruments where all musicians can share recordings of music from each of their instruments with each other.

With multiple instruments, the method for using the system 10a can comprise recording, storing, transmitting, and transcribing the music 22a from the first musical instrument 14a. Recording music 22a from the first musical instrument 14a can be done via the sound-capturing device 12a. Storing a recording of the music 22a from the first music instrument 14a can be done, via the memory 18a. Transmitting the recording 20a of the music 22a to the remote computing device 26a may be done via the communication module 24a. Transcribing the recording 20a of the music 22a into musical notes 30 may be done via the software application 28. In some embodiments, the system is a self-contained system, which means that the software application 28 alone is able to record and store, and even transcribe the music into musical notes and/or tablature. However, in some embodiments, the software application 28, via the remote computing device 26, is communicatively coupled with a remote server. In such embodiments, the remote server stores the music and even transcribes the music into musical notes and/or tablature. Because the remote computing device 26 is communicatively coupled to the remote server, the user may be able to retrieve the music and/or transcription at a later date.

For recording and transcribing music in an ensemble or band setting, instruments in the group can have access to another instrument's recordings 20 and transcriptions 74. The method for recording and transcribing music 22 can further comprise discovering, via the communication module 24, at least a second system 10b. When a second system 10b is discovered, the method can comprise pairing, via the communication module 24, the first system 10 with a second system 10b. The method can also comprise pairing, via the first remote computing device 26, the first system 10 with the second system 10b. In this regard, the first system 10a and the second system 10b may communicate with each other via their respective communication modules 24a, 24b and/or their remote computing devices 26a, 26b. If multiple systems or instruments are in discovery mode, more than one system may be paired to the first system 10. Accordingly, each instrument would be part of a system that could comprise an instrument 14, sound-capturing device 12, memory 18, communication module 24, control device 16, remote computing device 26, and software application 28.

It should be noted that each individual system can act as a stand-alone system without pairing with other instruments. This means that the second system 10b can have the same capabilities of the first system 10a. The second system 10b can use the same method of recording, storing, transmitting, and transcribing as the first system 10a.

In addition to transmitting recordings to a remote computing device 26, instruments in a group can transmit music 22 to the other instruments in the ensemble. The method of using the disclosed system can further comprise transmitting, via the second remote computing device 26b, the recording 20b of the music 22b to the first remote computing device 26a. The system can thereby also comprise transmitting, via the first remote computing device 26a, the recording 20a of the music 22a to the second remote computing device 26b.

It should be appreciated that recorded music from a second instrument 14b can also be played on a second remote computing device 26b, such as a smartphone. The system 10b can emit a playback 70 of the recording 20b of the music 22b from the second music instrument 14b via a speaker 72b of the second remote computing device 26b. A transcription 74b of the recording 20b of music 22b from the second music instrument 14b can be displayed via a display screen 76b on the second remote computing device 26b.

In this regard, not only can the remote computing device 26a of the first system 10a play music 22a recorded from the first instrument 14a, but also the first remote computing device 26a can have the ability to play music 22b recorded from the second remote computing device 26b. The method can further comprise emitting the playback 70b of the recording 20b of the music 22b from the second music instrument 14b via the speaker 72a of the first remote computing device 26a. A transcription 74b of the recording 20b of the music 22b from the second music instrument 14b can be displayed via the display screen 76a on the first remote computing device 26a. Likewise, the method can further comprise emitting the playback 70a of the recording 20a from the first music instrument 14a via the speaker 72a of the second remote computing device 26b. As well, the transcription 74a of the recording 20a from the first music instrument 14a can be displayed via the display screen 76b on the second remote computing device 26b. Accordingly, the music 22a recorded from the first instrument 14a can also be played on the second remote computing device 26b and the transcription 74a of the music 22a from the first instrument 14a can be displayed on the second remote computing device 26b.

Because many users are now utilizing cloud servers (i.e. remote servers) to retain and store files, the method of using the system 10 can further comprise transmitting the recording 20 of the music 22 from the first music instrument 14a and/or second instrument 14b to a remote server 80 that can be communicatively coupled to at least one of the first system 10a and the second system 10b. The remote server can be, for example, a personal server, or the Cloud.

### Guitar and Bass Embodiments

Assume a songwriter was practicing by him/herself when they spontaneously created a great riff. Using a control device 16 (e.g. a toggle switch) located on the guitar 14, the user could instantly engage the system's recording function. Once the recording is initiated, everything the user plays on the instrument is captured and stored on the onboard memory 18. The user can stop the recording process at any time by using the control device 16, and the recording will be stored on the onboard memory 18. This process can be repeated time and again, so the user can record multiple takes.

When the user wants to upload a performance (or series of performances) onto the mobile application 28, the user will place the system into transmit mode by using the control device 16 to initiate the wireless transmission of the performance(s) to the mobile application 28. Once the mobile application 28 is opened, all of the performances stored on the system 10 will transfer wirelessly from the onboard memory 18 to the user's mobile application 28 (e.g. software application).

The performance(s) will then appear in the mobile application 28, complete with note for note transcription. The performance and the transcription can be manipulated, edited, played back, and shared with others.

The system can thereby be equipped with sufficient onboard memory 18 to store several songs, or even a full concert. In some embodiments, the user receives a notification on the remote computing device 26 when the memory 18 is almost full.

### Amplifiers, Effects Pedals, Recording Consoles, and Auxiliary Devices

The systems and methods disclosed herein can also be imbedded into nearly every type of music-related device 14. The wireless transmission capabilities may also allow the systems and methods to work together and function seamlessly.

For example, today if a musician wants to run their guitar to an effects pedal, and from the effects pedal into an amplifier, this is typically done through a series of cables. However, if the guitar, pedal, and amplifier were equipped with the systems and methods disclosed here, the user could use the mobile application 28 to sync her/his guitar to the effects pedal, and the effects pedal to the amplifier. The signal flow may then wirelessly go from the instrument 14a, to the effects pedal 14b, and from the effects pedal to the amplifier 14c.

When the user engages the record function on the instrument 14a, the instrument 14a may record everything that is played, the effects pedal 14b can record the settings, and the amplifier 14c may record the performance and the settings. The recording from the instrument 14a may sound different than the recording from the amplifier 14c because the system on the instrument 14a is picking up the sound from the instrument 14a (so it will therefore be a clean tone), while the amplifier 14c is picking up the sound after it's been altered by the effects pedal 14b, and colored by the amplifier 14c itself.

The user can transmit data from all 3 pieces of equipment 14a, 14b, and 14c simultaneously, and in some embodiments, in real-time, by using the toggle switch to place her/his instrument 14a into transmit mode. Once the mobile application 28 is opened, recordings from all 3 pieces of equipment 14a, 14b, 14c will transmit to the mobile application 28.

Additionally, an amplifier 14c equipped with the system 10 could pair with more than one instrument 14a, so multiple instruments 14 could play through the same amplifier 14c. In such embodiments, this may require a multi-speaker amplifier 14 such that each instrument 14 could be assigned to a unique speaker.

### Microphones Embodiments

Systems 10 including a microphone 14, will be able to record and store any sounds they capture. This may be ideal for performers like singers, drummers, pianists, and violinists. The microphone 14 may ensure that any musician will be able to record their performance and join a session (of multiple systems 10), as previously described. Sounds captured by the microphone 14 can be uploaded to the mobile application 28 and, in some embodiments, transcribed into a readable format.

### Implementation

The aforementioned embodiments can be implemented, for example, using a machine-readable medium or article which is able to store an instruction or a set of instructions that, if executed by a machine, can cause the machine to perform a method and/or operations described herein. Such machine can include, for example, any suitable processing platform, computing platform, computing device, processing device, electronic device, electronic system, computing system, processing system, computer, processor, or the like, and is able to be implemented using any suitable combination of hardware and/or software.

The machine-readable medium or article can include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions can include any suitable type of code, for example, source code, compiled code, interpreted code, executable code, static code, dynamic code, or the like, and is able to be implemented using any suitable high-level, low-level, object-oriented, visual, compiled and/or interpreted programming language, e.g., C, C#, C++, Java, BASIC, Pascal, Fortran, Cobol, assembly language, machine code, or the like. Functions, operations, components and/or features described herein with reference to one or more embodiments, is able to be combined with, or is able to be utilized in combination with, one or more other functions, operations, components and/or features described herein with reference to one or more other embodiments, or vice versa.

### Interpretation

It should be appreciated that the music instrument can include any type of device or instrument that captures, records, alters, produces or reproduces sound, such as a percussion instrument (e.g. drums, pianos, bongos, and the like), a brass instrument (e.g. trumpets, trombones, tubas, and the like), an electrical instrument (e.g. keyboards, turn tables, synthesizers, electronic drums, and the like), a woodwind instrument (e.g. saxophones, flutes, clarinets, and the like), and a string instrument (e.g. guitars, banjos, basses, ukuleles and the like), and musical accessories, and recording equipment (e.g. amplifiers, preamplifiers, sound processers, audio processors, speakers, effects pedals, effect microphones, recording consoles, mixing consoles, and the like).

It should also be appreciated that musical notes are a notation that represents musical pitches and duration of the pitches. Tablature can show a person how to play musical pitches with visual representations of the fingering of an instrument. In this regard, the term tablature can be interpretted to mean a form of musical notation indicating fingering rather than the pitch of notes, written on lines corresponding to, for example, the strings of a guitar or the holes on a flute. Tablature is often shortened to TAB.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments include A, B, and C. The term “and/or” is used to avoid unnecessary redundancy.

Although the embodiments herein are described with various specific embodiments, it will be obvious for a person skilled in the art to practice the invention with modifications. However, all such modifications are deemed to be within the scope of the claims. While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

Furthermore, the foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

The following is claimed:

1. A system for recording and transcribing music, comprising:
a sound-capturing device arranged and configured to couple to a music instrument, wherein the sound-capturing device records music;
a control device communicatively coupled to the sound-capturing device and arranged and configured to couple to the music instrument, wherein the control device is configured to activate the sound-capturing device;
memory communicatively coupled to the sound-capturing device and arranged and configured to couple to the music instrument, wherein the memory is configured to store a recording of the music from the music instrument; and
a communication module communicatively coupled to the memory, wherein the communication module is arranged and configured to wirelessly transmit data.

2. The system of claim 1, further comprising:
a remote computing device communicatively coupled to the communication module; and
a software application implemented on the remote computing device, wherein the remote computing device is configured to audibly playback the recording of the music from the music instrument via the software application, and wherein the software application is configured to transcribe the recording of the music from the music instrument into one of musical notes and tablature.

3. The system of claim 2, further comprising the music instrument, wherein the sound-capturing device is coupled to the music instrument, the control device is coupled to the music instrument, and the memory is coupled to the music instrument.

4. The system of claim 3, wherein the music instrument defines at least one of a percussion, brass, electrical, woodwind, and string instrument.

5. The system of claim 2, wherein the control device comprises at least one of a pickup selector, a knob, a button, and an LCD screen.

6. The system of claim 2, wherein the sound-capturing device comprises at least one of a pickup and microphone.

7. The system of claim 3, wherein the control device is operable in a recording mode whereby the control device commands the sound-capturing device to record music, and a transmit mode whereby the control device causes the system to transmit the recording to the remote computing device.

8. The system of claim 7, further comprising:
a second music instrument;
a second sound-capturing device coupled to the second music instrument, wherein the second sound-capturing device records music;
a second control device communicatively coupled to the second sound-capturing device and coupled to the second music instrument, wherein the second control device is configured to activate the second sound-capturing device;
a second memory communicatively coupled to the second sound-capturing device and coupled to the second music instrument, wherein the second memory is configured to store a recording of the music from the second music instrument;
a second communication module communicatively coupled to the second memory, wherein the second communication module is arranged and configured to wirelessly transmit data; and
a second remote computing device communicatively coupled to the second communication module, wherein the software application is implemented on the second remote computing device, wherein the second remote computing device is configured to audibly playback the recording via the software application.

9. The system of claim 8, wherein the music instrument is a first music instrument and the remote computing device is a first remote computing device, and wherein the control device is further operable in a discovery mode whereby the first remote computing device and the second remote computing device are able to communicate with each other whereby the first remote computing device is able to receive the recording of the music from the second music instrument and whereby the second remote computing device is able to receive the recording of the music from the first music instrument.

10. A method of recording and transcribing music using a system comprising a sound-capturing device coupled to a first music instrument, a control device communicatively coupled to the sound-capturing device and coupled to the first music instrument, memory communicatively coupled to the sound-capturing device and coupled to the first music instrument, a communication module communicatively coupled to the memory, a remote computing device communicatively coupled to the communication module, and a software application implemented at least in part by the remote computing device, the method comprising:
recording, via the sound-capturing device, music from the first music instrument;
storing, via the memory, a recording of the music from the first music instrument;
transmitting, via the communication module, the recording of the music to the remote computing device; and
transcribing, via the software application, the recording of the music into musical notes.

11. The method of claim 10, wherein the recording step occurs in response to receiving a first input via a control device communicatively coupled to the sound-capturing device and coupled to the first music instrument, the method further comprising terminating the recording in response to receiving a second input via the control device.

12. The method of claim 11, further comprising:
emitting a playback of the recording via a speaker of the remote computing device; and
displaying a transcription of the recording via a display screen on the remote computing device.

13. The method of claim 12, wherein the system is a first system and the remote computing device is a first remote computing device, the method further comprising discovering, via the communication module, at least a second system; and pairing, via the communication module, the first system with a second system comprising a second sound-capturing device coupled to a second music instrument, a second control device communicatively coupled to the second sound-capturing device and coupled to the second music instrument, a second memory communicatively coupled to the second sound-capturing device and coupled to the second music instrument, a second communication module communicatively coupled to the second memory, a second remote computing device communicatively coupled to the second communication module, and the software application implemented at least in part by the second remote computing device.

14. The method of claim 12, wherein the system is a first system, the method further comprising discovering, via the communication module, at least a second system; and further comprising pairing, via the first remote computing device, the first system with the second system comprising a second sound-capturing device coupled to a second music instrument, a second control device communicatively coupled to the second sound-capturing device and coupled to the second music instrument, a second memory communicatively coupled to the second sound-capturing device and coupled to the second music instrument, a second communication module communicatively coupled to the second memory, a second remote computing device communicatively coupled to the second communication module, and the software application implemented at least in part by the second remote computing device.

15. The method of claim 14, further comprising:
recording, via the second sound-capturing device, music from the second music instrument;
storing, via the second memory, a recording of the music from the second music instrument;
transmitting, via the second communication module, the recording of the music from the second music instrument to the second remote computing device; and
transcribing, via the software application, the recording of the music from the second music instrument into musical notes.

16. The method of claim 15, wherein the communication module is a first communication module, the method further comprising:
transmitting, via the second remote computing device, the recording of the music to the first remote computing device; and
transmitting, via the first remote computing device, the recording of the music to the second remote computing device.

17. The method of claim 16, further comprising:
emitting a playback of the recording of the music from the second music instrument via at least one of a speaker of the second remote computing device and a speaker communicatively coupled to the second remote computing device; and
displaying a transcription of the recording of the music from the second music instrument via a display screen on the second remote computing device.

18. The method of claim 16, further comprising:
emitting the playback of the recording of the music from the second music instrument via at least one of the speaker of the first remote computing device and a speaker communicatively coupled to the first remote computing device; and
displaying the transcription of the recording of the music from the second music instrument via the display screen on the first remote computing device.

19. The method of claim 16, further comprising:
emitting the playback of the recording of the music from the first music instrument via at least one of the speaker of the second remote computing device and a speaker communicatively coupled to the second remote computing device; and
displaying the transcription of the recording of the music from the first music instrument via the display screen on the second remote computing device.

20. The method of claim 19, further comprising:
transmitting the recording of the music from the first music instrument to a remote server communicatively coupled to at least one of the first system and the second system; and
transmitting the recording of the music from the second music instrument to the remote server.
